(19) United States
(12) Patent Application Publication
(10) Pub. No.: US 2013/0261900 A1
(43) Pub. Date: Oct. 3, 2013

(54) OCCUPANT PROTECTION SYSTEM

(71) Applicant: TK HOLDINGS INC., Auburn Hills, MI (US)

(72) Inventors: Jialou HU, Auburn Hills, MI (US); James Peter Karlow, Commerce Township, MI (US)

(73) Assignee: TK Holdings Inc., Auburn Hills, MI (US)

(21) Appl. No.: 13/830,443

(22) Filed: Mar. 14, 2013

Related U.S. Application Data
(60) Provisional application No. 61/618,525, filed on Mar. 30, 2012.

(51) Int. Cl. B60R 21/0132

(52) U.S. Cl. CPC B60R 21/0132
USPC 701/45

(57) ABSTRACT

An occupant protection system is used to protect an occupant from vertical acceleration of a vehicle. The system includes a sensor that detects when a vehicle is subjected to vertical acceleration and a lowering means for a vehicle seat. The seat lowering means actively lowers, or forces the seat in a generally downward direction based on a signal from the sensor. Also, a seat for a vehicle includes a support that may withstand a vertical acceleration of the vehicle, a sensor that may detect the vertical acceleration, and a seat lowering means. The seat is connected to the support, and the seat may slide in a downward direction relative to the support. The seat is lowered by the seat lowering means at least partly in response to a signal from the sensor.

### CROSS-REFERENCE TO RELATED PATENT APPLICATIONS

This application claims priority from U.S. Provisional Patent Application No. 61/618,525, filed Mar. 30, 2012. The foregoing provisional patent application is incorporated herein by reference in its entirety.

### BACKGROUND

The present disclosure relates generally to the field of occupant protection systems for use in vehicles. Conventional restraint systems are used to restrain an occupant, for example, a vehicle occupant, within a vehicle seat during normal operation of the vehicle, and also during vehicle emergencies, such as a vehicle collision. In order to provide further protection to a vehicle occupant, conventional restraint systems may be designed to absorb some of the force that is generated from a collision. For example, a restraint system may include various devices such as pretensioners and seat belt webbing to absorb force generated during a collision.

The current restraint system that are relied upon to restrain an occupant of a vehicle from a significant vertical acceleration is generally based on a conventional seatbelt system. This system does not adequately protect an occupant from extreme vertical acceleration, nor does the system protect an occupant from typical events that follow as an effect of an extreme vertical acceleration. It would be advantageous to provide an improved occupant protection system that addresses one or more of the aforementioned issues.

### SUMMARY

An exemplary embodiment of the disclosure relates to an occupant protection system for protecting an occupant of a vehicle from a vertical acceleration of the vehicle. The occupant protection system includes a sensor used to detect the vertical acceleration of the vehicle, a device for lowering a vehicle seat, and a controller configured to receive input from the sensor and to control the device to lower the vehicle seat based on the input from the sensor.

Another exemplary embodiment of the disclosure relates to a seat for a vehicle. The seat includes a support coupled to a bottom of the seat, a sensor configured to detect a vertical acceleration of the vehicle, and a seat lowering device. The seat bottom is configured to move a downward direction relative to the support, and a controller configured to receive input from the sensor and to control the seat lowering device to lower the seat bottom based on the input from the sensor.

Yet another exemplary embodiment of the disclosure relates to a method for protecting an occupant seated in a seat located in a vehicle from vertical acceleration. The steps comprising the method include detecting the vertical acceleration of the vehicle and lowering the vehicle seat when the vertical acceleration is excessive.

### BRIEF DESCRIPTION OF THE DRAWINGS

FIG. 1 is a perspective view of an occupant protection system, according to an exemplary embodiment.

FIG. 2 is a side perspective view of the occupant protection system shown in FIG. 1, which is used by an occupant prior to a significant vertical acceleration, according to an exemplary embodiment.

FIG. 3 is a side perspective view of the occupant protection system shown in FIG. 1, which is used by an occupant during a significant vertical acceleration, according to an exemplary embodiment.

### DETAILED DESCRIPTION

According to various exemplary embodiments, an occupant protection system, as disclosed herein, may be configured to reduce the chance of injury to a vehicle occupant that may result from a significant vertical acceleration of a vehicle (such as an acceleration caused by an explosion from underneath the vehicle, which may be as high as approximately 200 G). Such a system may include several components, or several subsystems, that are integrated as the occupant protection system. For example, the occupant protection system may include, but is not limited to, an active seat lowering subsystem, a seat restraint subsystem, a seat energy absorber, a seat airbag subsystem, a controller, a blast sensor, an accelerometer, or any suitable combination thereof.

According to an exemplary embodiment, each individual device, subassembly, and component may play a supporting role in improving occupant protection in a blast-induced vertical acceleration. Further, the controller of the occupant protection system is configured to monitor and/or control at least one sensor(s) in order to coordinate the operation of each individual subassembly and/or device comprising the occupant protection system.

In addition, multiple phases may be defined for which the occupant protection system is configured to reduce the likelihood of injury to a vehicle occupant. For example, three separate phases are disclosed herein, each of which may be accounted for by the occupant protection system in order induce injuries to a vehicle occupant in the aftermath of an event that causes a significant vertical acceleration.

The first phase may immediately follow an explosion, and may be characterized by a significant vertical acceleration of the vehicle, during which the vehicle begins to move upwardly. During the first phase, the extreme vertical acceleration of the vehicle may induce injury of a vehicle occupant. The second phase may be characterized as a period of time during which the vehicle is airborne. During the second phase, the occupant may be injured as a result of contact with the interior of the vehicle, such as an occupant hitting his head against the vehicle roof and/or other interior components of the vehicle. The third phase may be characterized as the vehicle impacting the ground (e.g., the tires come back into contact with the ground). During the third phase, an occupant may be injured as a result of an abrupt change in vertical acceleration of the vehicle when it impacts the ground.

Although an occupant may suffer an injury during each of the three phases, the first and third phases may pose a relatively greater risk of injury to an occupant. This may be particularly true if the occupant is restrained in the vehicle seat (e.g., the occupant is wearing a seat belt or a seat harness). For example, test data shows that the forces exerted on an occupant are greatest during the first and third phases of vehicle movement. According to an exemplary embodiment, the occupant protection system is configured to separately mitigate the likelihood of injury to an occupant during each of the three phases herein described. Further, the occupant protection system is configured to determine which of the three phases it should react to, in order to mitigate the likelihood of injuries to an occupant. Accordingly, the occupant protection system is configured to work in conjunction with the three phase developments in order to mitigate the likelihood of injuries to an occupant.

Furthermore, a typical injury a vehicle occupant might suffer from an external explosion is a lower spinal injury. Accordingly, the occupant protection system disclosed herein may be configured to mitigate the likelihood of a lower spinal injury. However, it should be understood that the occupant protection systems disclosed herein, according to various exemplary embodiments, are configured to reduce the likelihood of injuries other than a lower spinal injury (i.e., other secondary injuries).

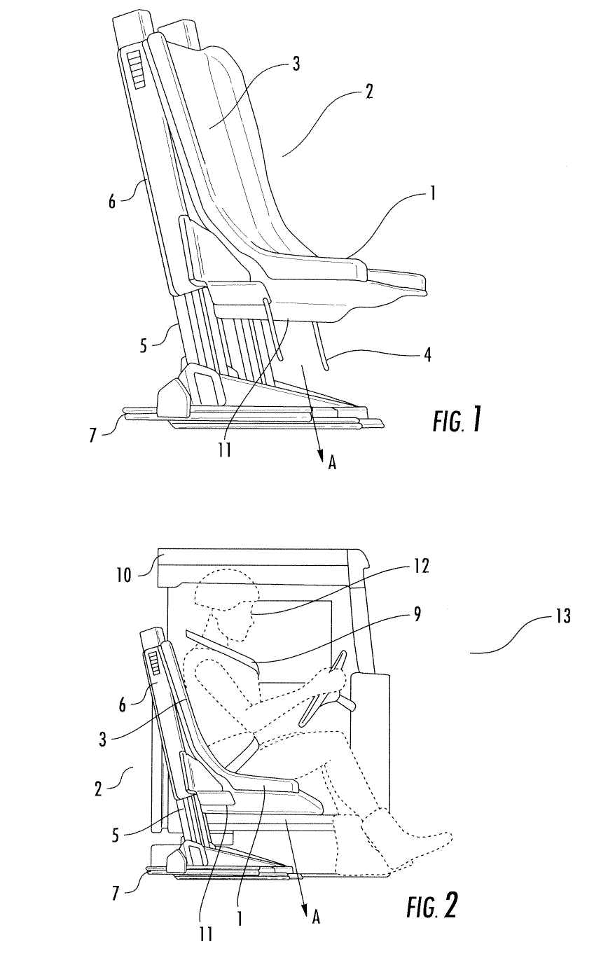

Referring to FIG. 1, and according to an exemplary disclosed embodiment, the vehicle seat 2 is configured to protect an occupant during the first phase of the vehicle movement that follows an external blast occurring below the vehicle. For example, the vehicle seat 2 is configured to counteract a force (i.e., mitigate or reduce the effects of a force) that may act upon a vehicle occupant, which is caused by a significant vertical acceleration of the vehicle. In other words, the vehicle seat 2 is configured to accelerate downwards in order to counteract the upward acceleration of the vehicle caused by an external explosion. The occupant protection system may include an active seat lowering subsystem that is configured to actively force the vehicle seat to accelerate in a downwardly direction, such as the direction “A” shown in FIG. 1. For example, a device may be used to push or pull the vehicle seat and the seat bottom (including the cushion) in the direction A. Advantageously, the forces that may be transferred to the occupant during the first phase of vehicle movement, which is characterized from a significant vertical acceleration, may be reduced or mitigated by the active seat lowering subsystem.

The seat-mounted protective device may be configured to force the vehicle seat in a downward direction in order to create a space between an occupant and the seat, or to increase the space between an occupant and the seat. In addition, the force imparted onto the seat bottom 1 by the occupant protection system can be induced directly by an inflator (e.g., without inflating a cushion), a motor or motor and gear combination, or by any other suitable device that is able to produce the force necessary to move the seat downwardly. For example, as described further below, the seat may be pulled down by straps.

The vehicle seat 2 includes a seat back 3 and a seat bottom. The seat bottom 1 may include a cushion or pad, a seat pan and other supporting structure. The seat bottom 1 may be configured for an occupant to sit thereon. Also, the seat back 3 and the seat bottom 1 may be separate pieces, or integrally formed as one piece, according to various exemplary embodiments. Further, a left and right side of the seat bottom 1 may be coupled to a side rail 6. Each side rail 6 is configured to be coupled to a support member 5. Further, the side rails 6 and the support members 5 may be configured to absorb energy. For example, the side rails 6 and the support members 5 may be coupled to a variety of energy absorbing elements (e.g., a spring, damper, energy tube, etc.). Each support member 5 is coupled to a floor support 7 of the vehicle, and each support member 5 may be reinforced in order to withstand a significant vertical acceleration of the vehicle (i.e., during the first phase of vehicle movement after an external explosion). Therefore, each support member 5 may be configured to withstand the stresses and forces caused by an external explosion of a vehicle, and to support the vehicle seat 2 and an occupant seated thereon.

Additionally, the side rails 6 and the seat bottom 1 may be configured to slideably move between a normal position and a lowered position in the direction “A”, as shown in FIG. 1. The seat bottom 1 and the side rails 6 may slideably move relative to the support members 5, which are fixed in place relative to the floor of the vehicle. According to various exemplary embodiments, the seat bottom 1 may be configured to move independently from, or cooperatively with, the seat back 3. It should be understood that while a particular vehicle seat is shown in the FIG. 1, vehicles seats of other occupant protection systems may include a variety of other components, which may be coupled to the vehicle in a variety of ways, according to other exemplary embodiments.

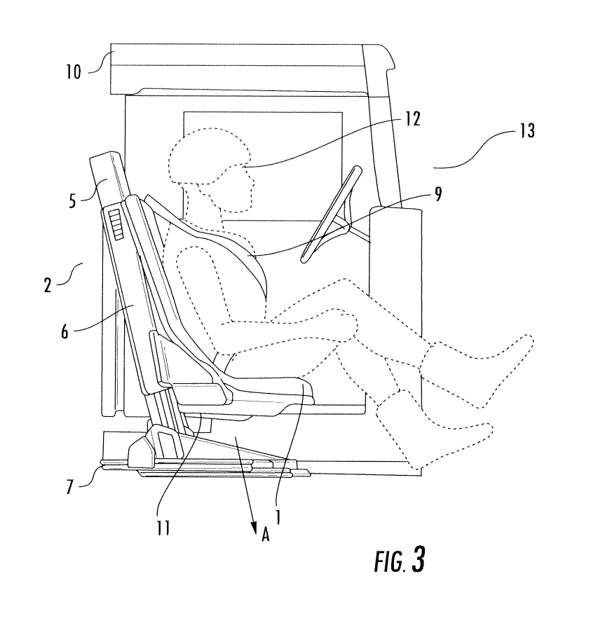

Referring to FIGS. 2-3, according to an exemplary embodiment, a plurality of straps 4 may be coupled to, and hang downward from, a bottom portion 11 of the vehicle seat 2. The straps 4 may be made out of a variety of materials (i.e. nylon webbing, or a steel cable) that are able to withstand a tensile force used to pull the vehicle seat 2 into the lowered position. Also, the straps 4 are configured to be pulled in the downward direction “A,” which is shown as an oblique downward direction. When the straps 4 are pulled in the direction A, the vehicle seat 2 may slideably move relative to the support members 5 in the direction A. The straps 4 may be coupled to a variety of devices that operate to pull the straps 4 in the direction A. For example, a high output electric motor may be used to pull and/or wind the straps 4. Also, a push-pull solenoid actuator may be used to pull the straps 4. A spring system may also be used to actively force the vehicle seat 2 downwards. It should be understood that a variety of devices may be used to actively force a vehicle seat in a downward direction, according to other exemplary embodiments. Also, this disclosure is not intended to limit the possible devices that may be used to actively force a vehicle seat in a downward direction.

In order to provide further protection to a vehicle occupant during the first phase after an external explosion, a variety of energy-absorbing devices may be used in combination with an active seat lowering subsystem. For example, the occupant protection system may include an energy absorbing mechanism, such as a spring and damper assembly, to absorb energy cause by a significant vertical acceleration of the vehicle. A spring and damper assembly (energy absorbing springs, energy absorbing foam, supplementary energy absorbing devices, etc.) may be incorporated within the seat bottom 1 and/or the seat back 3 of the vehicle seat 2. Such a spring and damper assembly may also absorb energy when the seat bottom 1 and/or the seat back 3 slide or move relative to the support member 5. Further, in order to reduce the likelihood of an occupant suffering an injury during the first phase, a spring and damper assembly may be used in parallel with an active seat lowering subsystem that is used to actively force the seat bottom 1 in a downward direction.

The first phase of vehicle movement, which is characterized by a significant vertical acceleration, may include two separate periods. For example, the first phase may include an initial period, which immediately follows an external explosion, and a secondary period, which may occur moments after the vehicle experiences a significant vertical acceleration due to the external explosion. The forces that may be exerted on a vehicle occupant, and the likelihood for injury to the occupant, may be greatest during the initial period of the first phase.

During the initial period of the first phase, the active seat lowering subsystem may be used to lower the vehicle seat 2 in order to quickly counteract or mitigate the drastic change in vertical acceleration. As the seat is being lowered, the occupant may exert less force on the seat bottom 1 and/or the seat back 3, and the vehicle seat 2 may not absorb as much energy from the external explosion.

Thereafter, during the secondary period of the first phase, the vehicle seat 2 may reach a lowered position, and the vehicle may still be accelerating in a vertical direction. The vertical acceleration of the vehicle during the secondary period may be less, albeit still significant, than the vertical acceleration of the vehicle during the initial period. During the secondary period, the vehicle seat 2 may be configured to absorb energy from the vertical acceleration of the vehicle. For example, a spring and damper system may be positioned within the seat bottom 1 and/or the seat back 3, which may be used to absorb energy from the vertical acceleration of the vehicle. Therefore, a spring and damper system may be used in combination with an active seat lowering system to effectively reduce or mitigate the force exerted on an occupant during the first phase of an external explosion. As a result, the force on the pelvis and lower spine of an occupant during the first phase of vehicle movement may be reduced.

The first phase of vehicle movement after an external explosion, which is characterized as a significant vertical acceleration of the vehicle, may start immediately after the explosion and last for approximately 150 ms depending on the strength of the explosion. In order to detect and respond to an external explosion, the occupant protection system may include a plurality of sensors. The sensors used in the occupant protection system may include, but are not limited to, blast sensors that can sense the initiation of a strong vertical acceleration from a blast. These sensors are able to differentiate between a blast and other relatively low acceleration incidents. Another possible sensor that could be employed is an accelerometer that measures acceleration in the Z (i.e. vertical) direction and includes a processor for analyzing an unexpected spike or pulse in the vertical acceleration that may indicate a blast. A seatbelt sensor that monitors the pulling-out of the seat belt may also be employed. The device may also include a weight sensor for determining occupant weight and/or mass. For example, the sensor can be configured to sense occupant mass and status (e.g., size, percentage classification, location etc.). The system may also employ vision sensing in order to determine the location and status of the occupant and/or vehicle components during a vehicle blast. The system may be configured to include one or more of the above exemplary sensors, especially to allow the system to function using a more comprehensive algorithm that may be needed to control the occupant kinematics during a blast.

The sensors of a occupant protection system may be coupled to the underside of the vehicle, and electronically coupled to a controller. Further, the sensors may be configured to detect an external explosion (i.e., the sensors may be oriented so as to best detect a typical external explosion underneath a vehicle). The sensors may detect an input, such as the magnitude of an external explosion, and transmit a signal of this magnitude to the controller of the occupant protection system.

The controller of the occupant protection system may use an algorithm which may have defined thresholds for an upper limit of each signal transmitted by either of a blast sensor, an accelerometer, or another sensor. These upper limits may be used to determine whether a blast is severe enough to actuate an active seat lowering subsystem for the vehicle seat 2. For example, Z direction acceleration thresholds may be defined inside the algorithm, and high frequency signals may be required in order to provide several samples over a relatively short time to confirm the blast event, and compute and/or analyze the blast severity. The frequency of the signals may be high enough to determine and provide for the system to react to an external explosion within 150 ms of the explosion. More particularly, according to an exemplary embodiment, the frequency of such a signal may be high enough to react to a blast within approximately 15 ms after the explosion. More particularly still, according to an exemplary embodiment, the frequency of such a signal may be high enough to react to a blast within approximately 3 ms after the explosion.

Accordingly, when the controller of the occupant protection system receives a signal that satisfies a pre-determined threshold, it may activate an active seat lowering subsystem. The various systems and methods used to lower the vehicle seat 2 in response to an external explosion may cooperatively operate to begin to lower the vehicle seat 2 within 150 ms of a blast. Therefore, the occupant protection system disclosed herein may be configured to counteract a significant vertical acceleration in order to protect a vehicle occupant.

A vehicle that is subject to an external explosion may undergo a second phase which is characterized by the vehicle being airborne (i.e., the wheels are off the ground). The second phase may begin approximately 150 ms after an external explosion, which is approximately when the first phase ends. Further, the duration of the second phase may be approximately 850 ms, so that the second phase may be complete approximately 1000 ms after an external explosion. During the second phase, the velocity of the vehicle decreases until it reaches a maximum height off the ground, after which the vehicle begins to fall back to the ground.

During the second phase, an occupant may be at greater risk of injury due to contact with the interior of the vehicle because the movement of the vehicle changes direction in the second phase. In order to protect an occupant from suffering an injury during the second phase, various devices and subsystems may be used to restrain the vehicle occupant within the vehicle seat 2. For example, a seat restraint, such as a seat belt or a seat harness, may be used in combination with other devices to restrain a vehicle occupant within the vehicle seat 2.

According to an exemplary embodiment, the occupant protection system includes a seat restraint subsystem, which is configured to control the rate of vertical acceleration of the vehicle occupant during the second phase. The seat restraint subsystem may include a motorized seat belt (MSB) system. The MSB operates to retract the seat belt in order to restrain the occupant and prohibit or reduce the likelihood of the occupant's head, from hitting the vehicle roof, such as during the second phase of the vehicle movement following the blast. Thus, the seat belt may limit the upward displacement of the occupant. The occupant protection system may also monitor the position of the occupant to prevent contact with the roof. The MSB may include a motorized retractor configured so that the motor operates to drive a spool, for example, to wind and retract the seat belt to provide restraining force to the occupant.

The system may include several devices for absorbing the energy of the occupant caused from the vertical acceleration of the vehicle. These devices may control the movement or excursion of the occupant using lap and/or shoulder belt loading to the occupant. For example, the webbing of the seat belt may be configured to stretch or deform in order to absorb energy. Also, a pretensioner and/or a force limiter for a seatbelt assembly may include an element that is configured to absorb energy through deformation. For example, a seat belt retractor may include a torsion bar for energy absorption. The operation of the system may be controlled by a controller(s) that monitors vehicle blast sensors or occupant status monitoring sensors and directs the operation of various subsystems, such as, seat belt subsystems. It should be understood that the various occupant protection systems described herein are not intended to limit the various devices that may be used to absorb energy caused by the vertical acceleration of a vehicle, and that other energy-absorbing devices may be used with the various exemplary embodiments described herein.

Also, during the second phase, the occupant may rise a distance from the vehicle seat 2, due in part to the upward excursion of the occupant prior to full restraint by the seat belt. A gap may be created between the occupant's pelvis and the seat bottom 1. This gap may be increased by the downward seat force applied during the first phase, which may continuously act thereafter on the seat bottom 1, and keep the vehicle seat 2 in a lowered position. The gap may be controlled using the seat belt devices and subsystems described above.

A vehicle that is subject to an external explosion may undergo a third phase which is characterized by the vehicle impacting the ground after having been airborne. The third phase may start approximately one second after the external explosion. When the vehicle falls back down to the ground, the occupant may impact or contact the vehicle seat 2, particularly the seat bottom 1. The impact of the vehicle with the ground may generally deliver a substantial force to the occupant's pelvis and lower spine. Therefore there may be a high risk for injury to these areas during the third phase.

The occupant protection system may include a seat airbag subsystem in order to protect a vehicle occupant during the third phase. The seat airbag subsystem may include an airbag, as well as a device used to inflate the airbag, such as a pyrotechnic inflator. The airbag may be positioned in a location between the occupant and the vehicle seat 2, such as within the seat bottom 1 or any other suitable location. The inflation device may inflate the airbag during the first or second phase of vehicle movement. Further, a sensor or the controller may control when the inflation device is actuated, thereby determining the time at which the airbag is inflated. There may be a space between the seat bottom 1 and the occupant, and the seat restraint system may be configured to control the space so as to reduce the impact of the occupant against the airbag when the vehicle impacts the ground.

Once the vehicle impacts the ground, the seat airbag is configured to cushion the occupant and absorb the force of the vehicle impact that may be exerted on the occupant, which is a force/pressure induced by a significant change in the vertical acceleration of the vehicle. Thereby, the likelihood of occupant injury may be reduced. In addition, the seat airbag subsystem may also include an active or passive venting device used to control the rate at which the airbag absorbs energy. For example, the venting device may be configured to control the rate at which gas is pushed out of the airbag/cushion (i.e., flow rate of gas exiting the inflatable cushion) when loaded by the occupant, such as after a relative high vertical acceleration.

According to an exemplary embodiment, the seat airbag may inflate during the middle of the second phase, or even earlier. A controller may be configured to determine (e.g., using an algorithm) the severity of a blast during the early portion of the first phase. The controller may also be configured to predict when the second and third phases occur. An inflation device may continue to inflate an airbag until the middle of the third phase. The amount of inflation of the airbag may be based on, for example, the acceleration of the vehicle in the vertical direction (e.g., the magnitude of the spike or pulse in vehicle acceleration due to a blast), and/or the weight of an occupant, as determined by the controller and various sensors. The system may employ multiple-stage inflators to ensure proper inflation of the seat airbag. Since the duration of inflation maybe relatively longer than required for vehicle crashes involving abrupt changes in the vehicle's horizontal acceleration, pre-storage gas from tanks may be utilized. The benefit to utilizing the gas storage tanks is that the tanks may be reusable, much like motorized seat belts (which do not require permanently activating or deforming components during seat belt pretensioning. For a situation where the spike or pulse in the vehicle's vertical acceleration is approximately 200 G's, the inflation may begin at approximately 200 ms after an external explosion, and a full inflation may be achieved at approximately 750 ms after an external explosion.

According to an exemplary embodiment, the occupant protection system may be configured such that an occupant restraint provides a pulling force during the third phase or close to the end of the second phase, and works or cooperates with the seat airbag to mitigate occupant injuries during the third phase. For the situation involving the 200 G's of vertical acceleration, the downward (e.g., pulling) force to the seat may start to be applied approximately 350 ms after an external explosion, for an occupant corresponding to the 50^{th} percentile occupant. A first force limiter or energy absorber, if included in the system, may operate around 200-350 ms after an external explosion, and a second force limiter or energy absorber, if included in the system, may operate around 850-1100 ms after an external explosion.

According to various exemplary embodiments, the controller of an occupant protection system may determine whether to initiate various subsystems used to protect a vehicle occupant, based on the signals from various sensors (i.e., a blast sensor, an accelerometer, or another sensor) in response to an external explosion. Based on the blast severity, the controller of an occupant protection system may control (i.e., initiate) any combination of subsystems in order to react to the particular forces created by an external explosion. Accordingly, depending on the circumstances of an external explosion, a system may elect or decide to operate in one of several modes.

According to an exemplary embodiment, an algorithm may determine whether the controller initiates a particular subsystem of the occupant protection system. Further, the algorithm may be based on test data, such as crash test data. Crash test data may be used to predict whether a particular force is likely to result in an injury to the vehicle occupant. Accordingly, the occupant protection system may include various sensors used to detect an external force. Upon detection of a force, the sensors may transmit a signal that represents a particular force to the controller. If the signal satisfies a particular threshold (i.e., one that may be based on crash test data), the controller may initiate a particular combination of subsystems in order to protect an occupant against the forces caused by a significant vertical acceleration of the vehicle.

For example, if the various sensors detect a relatively weak blast (i.e., a blast imparting a vertical acceleration of the vehicle of less than approximately 20 G), the sensors may transmit a signal that corresponds to the controller determining that the blast is below a threshold required to initiate a subsystem. Under other circumstances, for a moderate blast (i.e., causing vehicle acceleration of between approximately 20-80 G), the sensors may transmit a signal that corresponds to a determination by the controller that a threshold is exceeded and, as a result, the controller initiates at least one of the active seat lowering subsystem, seat restraint subsystem, and a seat airbag subsystem. Under circumstances for a significant blast (i.e., causing vehicle acceleration of between approximately 80-200 G), activation of all three of the active seat lowering subsystem, seat restraint subsystem, and seat airbag subsystem may be necessary.

When the controller makes a determination that the system should react to a significant external explosion, the occupant protection system may perform at least two actions. For the first action, the active seat lowering subsystem may pull straps 4 of the seat bottom 1, in order to move the vehicle seat 2 downward, relative to the support members 5. The period of time that the subsystem pulls the straps 4 may vary. For example, the active seat lowering subsystem may pull the straps 4 until a time that corresponds to the end of the third phase, the middle of the third phase, or any suitable period of time. For an exemplary situation involving an external explosion causing the vehicle to accelerate in the vertical direction at a rate of 200 G, the straps 4 may be pulled for about 750 ms after the external explosion. For the second action, the seat restraint subsystem (e.g., shoulder belts and lap belts) may allow the seatbelt to pull-out and stop at about the first half of the second phase (e.g., when the vehicle reaches a maximum height above the ground). For a situation where the spike in the vehicles vertical acceleration is about 200 Gs and the occupant is classified as about a 50^{th} percentile occupant, the seatbelt may stop moving at about 200 ms after the external explosion. Thereafter, a force limiter or energy absorber, if included in the system, may absorb energy from a significant vertical acceleration.

The controller may receive signals transmitted from various sensors that may represent occupant information (e.g., weight, size, position), belt pulling-out and monitoring information, and occupant kinematics vision information. The controller may use an algorithm based on the information or data received from the sensors to control the extraction length of the seatbelt. The seat restraint subsystem may sense the clearance space between an occupant's head and the roof of the vehicle. The subsystem may then control the length of the seatbelt in order to restrict or limit the excursion of the occupant's head and prevent the impact between the occupant's head and the roof. The belt extraction may be mechanically driven, such as by the force from the occupant, or electronically driven, through motor operation.

According to various exemplary embodiments, the thresholds employed by the algorithm used by the controller may be based on the particular properties of a vehicle. Such thresholds may be based on a particular vehicle configuration including, but not limited to the general arrangement, interior geometry, size, and mass of the vehicle. Accordingly, the injury prevention criteria for a specific vehicle may be defined and included in the design of the occupant protection system.

The description above refers primarily to a belted occupant. However, even if the occupant is unbelted, lowering the seat down may still reduce the force imparted onto the occupant. Although the seat airbag may not function as effectively for the unbelted occupant as for the belted occupant, the seat airbag may still provide some cushioning to the unbelted occupant, particularly if the kinematics of the occupant are a match.

According to an exemplary embodiment, the occupant protection system integrates the seat, various sensors, the active lowering seat subassembly, the seat restraint subassembly, and the seat airbag subassembly. Although, it should be noted that the operation of the occupant protection system may utilize any number of systems, such as any combination of the subsystems herein described. The systems employed in the occupant protection system can be categorized in two different types. The first type of system is an electronics system, which may include and/or involve various sensors, controllers and algorithms employed therein, actuators, data acquisition devices, and other electronics devices. The second type of system is the restraint system or assembly, which may include and/or involve a seat, a seatbelt, an airbag, a seat lowering device, an inflating device, and/or other suitable devices. The electronics system may monitor and/or control the restraint system to mitigate the injuries directly to the occupant. It should be noted that the parameters suggested in the examples disclosed herein are meant as examples and are not limiting.

FIGS. 1-3 illustrate various exemplary embodiments of an occupant protection system and are meant as examples of configurations of systems. The examples of occupant protection systems disclosed herein are not limiting.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the occupant protection systems as shown and described in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An occupant protection system for protecting an occupant of a vehicle from a vertical acceleration of the vehicle, the system comprising:
a sensor used to detect the vertical acceleration of the vehicle;
a device for lowering a vehicle seat; and
a controller configured to receive input from the sensor and to control the device to lower the vehicle seat based on the input from the sensor.

2. The system of claim 1, further comprising a support member for the vehicle seat and wherein the seat is configured to slide downwardly relative to the support member.

3. The system of claim 1, wherein the input received by the controller from the sensor is indicative of the vertical acceleration of the vehicle and wherein the controller is configured to direct the lowering of the vehicle seat when a value of a parameter based on the input exceeds a predetermined threshold value.

4. The system of claim 1, further comprising an airbag module including an inflator and an airbag, wherein the airbag is configured to inflate into a position between the occupant and the seat; and wherein the controller is configured to direct the inflation of the airbag.

5. The system of claim 4, wherein the input received by the controller from the sensor is indicative of the vertical acceleration of the vehicle and wherein the controller is configured to direct the inflation of the airbag when a value of a parameter based on the input exceeds a predetermined threshold value.

6. The system of claim 1, wherein the vehicle seat is coupled to a spring and damper, and the spring and damper are configured to absorb energy resulting from the vertical acceleration of the vehicle.

7. The system of claim 1, further comprising an occupant restraint system which is configured to control a vertical acceleration of the occupant.

8. The system of claim 1, wherein the occupant restraint includes a seat belt system including a seat belt webbing and a retractor, and wherein the seat belt system includes an energy absorbing mechanism.

9. A seat for a vehicle, the seat comprising:
a support coupled to a bottom of the seat;
a sensor configured to detect a vertical acceleration of the vehicle; and
a seat lowering device;
wherein the seat bottom is configured to move a downward direction relative to the support;
a controller configured to receive input from the sensor and to control the seat lowering device to lower the seat bottom based on the input from the sensor.

10. The seat of claim 9, wherein the input received by the controller from the sensor is indicative of the vertical acceleration of the vehicle and wherein the controller is configured to direct the lowering of the vehicle seat when a value of a parameter based on the input exceeds a predetermined threshold value.

11. The seat of claim 9, further comprising an airbag module including an inflator and an airbag, wherein the airbag is configured to inflate into a position between the occupant and the seat bottom; and wherein the controller is configured to direct the inflation of the airbag.

12. The seat of claim 11, wherein the input received by the controller from the sensor is indicative of the vertical acceleration of the vehicle and wherein the controller is configured to direct the inflation of the airbag when a value of a parameter based on the input exceeds a predetermined threshold value.

13. The seat of claim 9, wherein the scat is configured to absorb energy from the vertical acceleration of the vehicle.

14. The seat of claim 9, further comprising an occupant restraint system which is configured to control the vertical acceleration of an occupant.

15. The seat of claim 14, wherein the occupant restraint system includes a seat belt system including a seat belt webbing and a retractor, and wherein the seat belt system includes an energy absorbing mechanism.

16. A method for protecting an occupant seated in a seat located in a vehicle from vertical acceleration, the method comprising the steps of:
detecting the vertical acceleration of the vehicle; and
lowering the vehicle seat when the vertical acceleration is excessive.

17. The method of claim 16, further comprising the step of:
inflating an airbag between the vehicle seat and the occupant when the vertical acceleration is excessive.

18. The method of claim 16, wherein the vehicle includes a seat belt system for restraining the occupant, and the method further comprises the step of:
using the seat belt system to absorb energy from the occupant.
